(19) United States
(12) Patent Application Publication
(10) Pub. No.: US 2015/0233781 A1
(43) Pub. Date: Aug. 20, 2015

(54) MICRODUCT TESTING APPARATUS

(71) Applicant: Hubert Global Systems, Inc., Fraser, MI (US)

(72) Inventors: Christopher J. Hubert, Shelby Township, MI (US); John B. Ferguson, Shelby Township, MI (US); Duncan N. MacDiarmid, Kirkland, WA (US); Thomas J. Plummer, Clarkston, MI (US)

(73) Assignee: Hubert Global Systems, Inc., Fraser, MI (US)

(21) Appl. No.: 14/184,466

(22) Filed: Feb. 19, 2014

(51) Int. Cl. G01L 7/00

(52) U.S. Cl. CPC G01L 7/00

(57) ABSTRACT

An apparatus for testing a microduct includes an outlet configured to connect to a first end of the microduct, an inlet configured to connect to a second end of the microduct, an object sized to flow through the microduct in response to a sufficient air pressure, and a test passage coupled to the outlet and configured to receive the object. The apparatus also includes a testing plate having a hole sized to receive the object, a container coupled to the inlet and configured to receive the object from the microduct via the inlet, a pneumatic device configured to provide the sufficient air pressure, and a controller coupled to the first sensor. The controller is configured to, upon receiving the first signal from the first sensor, provide a first indication. If the first signal is not received within a specified time period, the controller is configured to provide a second indication.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Microducts are small ducts that are often used to route and protect wires or cables, such as optical fiber cables. Microducts may be bundled together into a sheath or larger duct to form a microduct bundle (e.g., microduct assembly) capable of storing a group of wires or cables. A microduct bundle is typically stored by wrapping the bundle around a spool, which may cause the bundle to be bent or otherwise compromised due to the weight of the bundle on the spool. If the microduct bundle is compromised, one or more of the microducts within the bundle may be blocked such that an optical fiber cable, for instance, cannot be routed through the microduct. As a result, microduct bundles are often tested (e.g., validated, verified) for clearance through each of the microducts within the bundle before the bundle is used.

Microduct bundles may be tested by sending an object through each of the microducts (e.g., via compressed air) to ensure proper clearance for a particular wire or cable. However, it may be time-consuming to test each microduct within the bundle individually. It may also be difficult to keep track of which microducts have been tested and verified. Also, an object that is improperly sized (e.g., too small) for a particular microduct may pass through the microduct even though the clearance is not sufficient for the intended use, resulting in a passing test for a defective bundle.

### SUMMARY

An embodiment of the present disclosure relates to an apparatus for testing a microduct. The apparatus includes an outlet configured to connect to a first end of the microduct, an inlet configured to connect to a second end of the microduct, an object sized to flow through the microduct in response to a sufficient air pressure, and a test passage coupled to the outlet and configured to receive the object. The apparatus also includes a testing plate having a hole sized to receive the object, the hole being configured to fluidly connect to the test passage to allow the object to pass through the hole into the test passage, a container coupled to the inlet and configured to receive the object from the microduct via the inlet, a pneumatic device configured to provide the sufficient air pressure to move the object through the microduct and into the container when the first end of the microduct is connected to the outlet and the second end of the microduct is connected to the inlet, a first sensor configured to generate a first signal upon detecting the object within the container, and a controller coupled to the first sensor. The controller is configured to, upon receiving the first signal from the first sensor, provide a first indication. The controller is also configured to, if the first signal is not received within a specified time period, provide a second indication.

Another embodiment of the present disclosure relates to an apparatus for testing a microduct bundle having a plurality of microducts. The apparatus includes outlets configured to connect to a first end of the microduct bundle, inlets configured to connect to a second end of the microduct bundle, objects configured to flow through the plurality of microducts in response to a sufficient air pressure, and test passages coupled to each of the outlets and configured to receive the objects. The apparatus also includes a plurality of testing plates, wherein each of the testing plates includes at least one hole sized to receive one of the objects, and a rack configured to store the plurality of testing plates, wherein the rack includes a locking assembly configured to prevent removal of the testing plates from the rack. The apparatus also includes a staging area configured to receive each of the testing plates, wherein each of the testing plates is movable from a load position to an unload position within the staging area, wherein the at least one hole is substantially blocked in the load position such that the objects cannot pass through the at least one hole, and wherein the at least one hole is substantially clear in the unload position such that one of the objects may pass through the hole and into the test passage. The apparatus also includes a container coupled to the inlets and configured to receive the objects from the microduct bundle via the inlets, a pneumatic device configured to provide the sufficient air pressure to move the objects from the test passages through the microduct bundle and into the container when the first end of the microduct bundle is connected to the outlets and the second end of the microduct bundle is connected to the inlets, a first sensor configured to monitor the container and generate a first signal upon detecting the objects within the container, and a controller coupled to the locking assembly and the first sensor. The controller is configured to, based on the microduct bundle, allow removal of a selected testing plate of from the rack by sending a signal to the locking assembly. The controller is also configured to, upon receiving the first signal from the first sensor, provide a first indication. If the first signal is not received within a specified time period, the controller is configured to provide a second indication.

Another embodiment of the present disclosure relates to a method for providing an apparatus for testing a microduct. The method includes providing an object sized to flow through the microduct in response to a sufficient air pressure, providing a test passage configured to fluidly connect to a first end of the microduct and sized to receive the object, and providing a testing plate having a hole sized to receive the object, wherein the testing plate is configured to be received by a staging area of the apparatus, and wherein the testing plate is movable within the staging area from a load position to an unload position, wherein the hole is closed to store the object in the load position and the hole is open to allow the object to enter the test duct in the unload position. The method also includes providing a container configured to be fluidly connected to a second end of the microduct and to receive the object from the microduct, wherein the container includes a first sensor configured to generate a first signal upon detecting the object within the container. The method also includes providing a pneumatic device coupled to the test duct and configured to provide the sufficient air pressure, and providing a controller coupled to the first sensor. The controller is configured to, upon receiving the first signal from the first sensor, provide a first indication. The controller is also configured to, if the first signal is not received within a specified time period, provide a second indication.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a microduct testing apparatus coupled to a microduct bundle, according to an exemplary embodiment.

FIG. 2 is a front perspective view of the microduct testing apparatus, according to an exemplary embodiment.

FIG. 3 is a back perspective view of the microduct testing apparatus, according to an exemplary embodiment.

FIG. 4 is a cross-sectional view of the microduct testing apparatus of FIG. 2 along the 4-4 line, according to an exemplary embodiment.

FIG. 5 is a front view of the microduct testing apparatus, according to an exemplary embodiment.

FIG. 6 is a front exposed view of the microduct testing apparatus, according to an exemplary embodiment.

FIG. 7 is a back view of the microduct testing apparatus, according to an exemplary embodiment.

FIG. 8 is a side view of the microduct testing apparatus, according to an exemplary embodiment.

FIG. 9 is an exposed side view of the microduct testing apparatus, according to an exemplary embodiment.

FIG. 10 is another side view of the microduct testing apparatus, according to an exemplary embodiment.

FIG. 11 is another exposed side view of the microduct testing apparatus, according to an exemplary embodiment.

FIG. 12 is a top view of the microduct testing apparatus, according to an exemplary embodiment.

FIG. 13 is a close-up view of a cartridge locking device for the microduct testing apparatus, according to an exemplary embodiment.

FIG. 14 is a perspective view of a test cartridge, according to an exemplary embodiment, according to an exemplary embodiment.

FIG. 15 is a top view of the test cartridge of FIG. 14, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

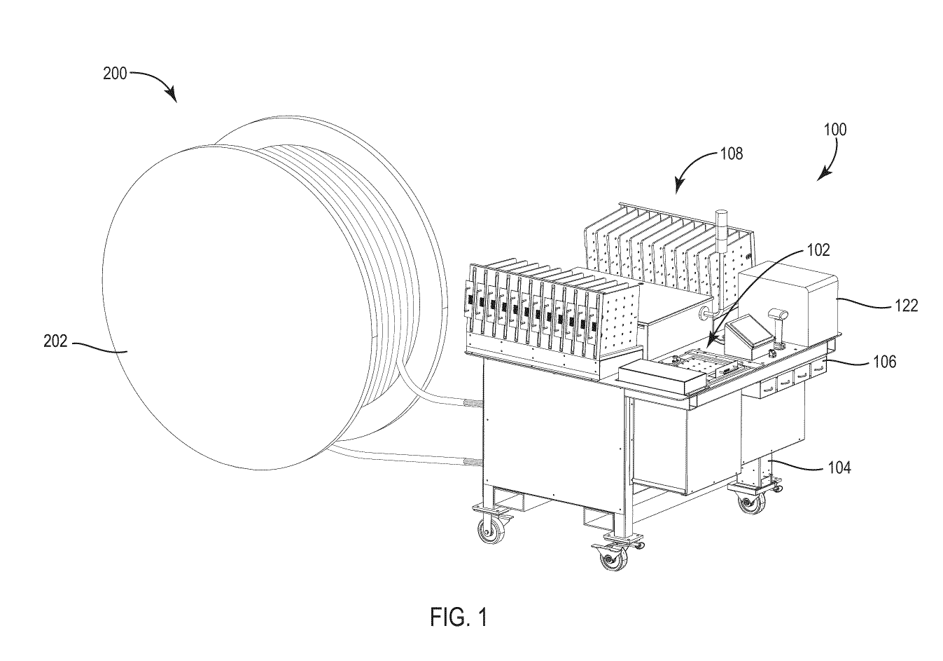

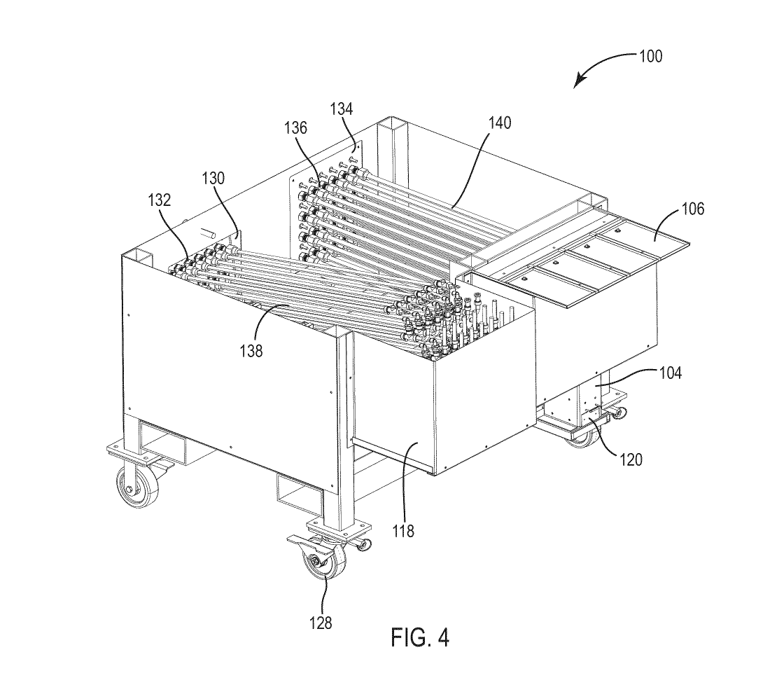

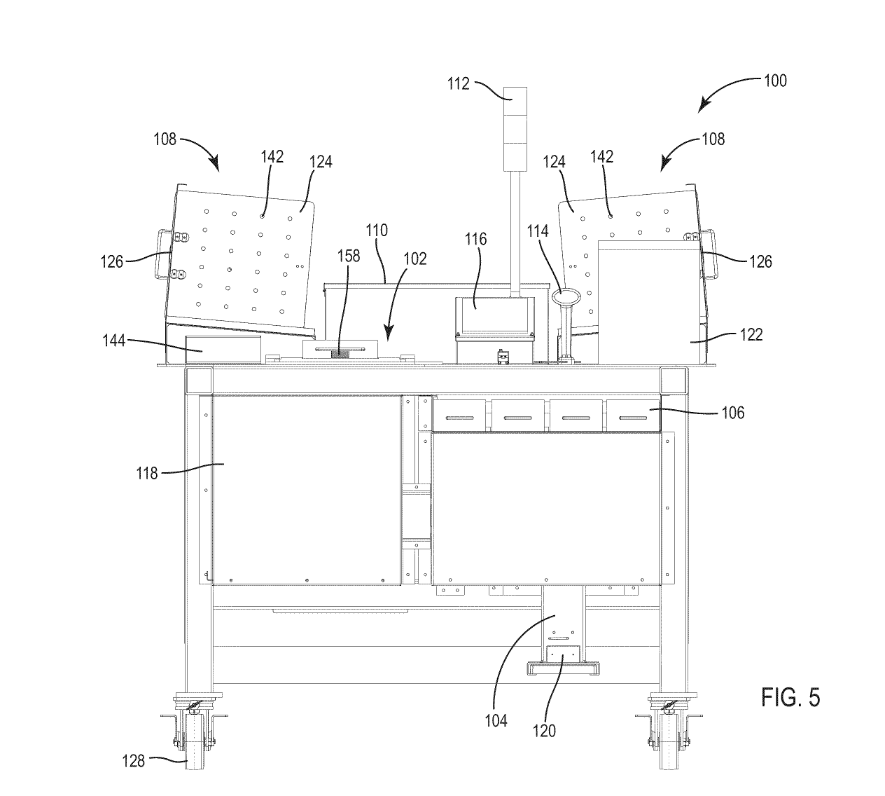

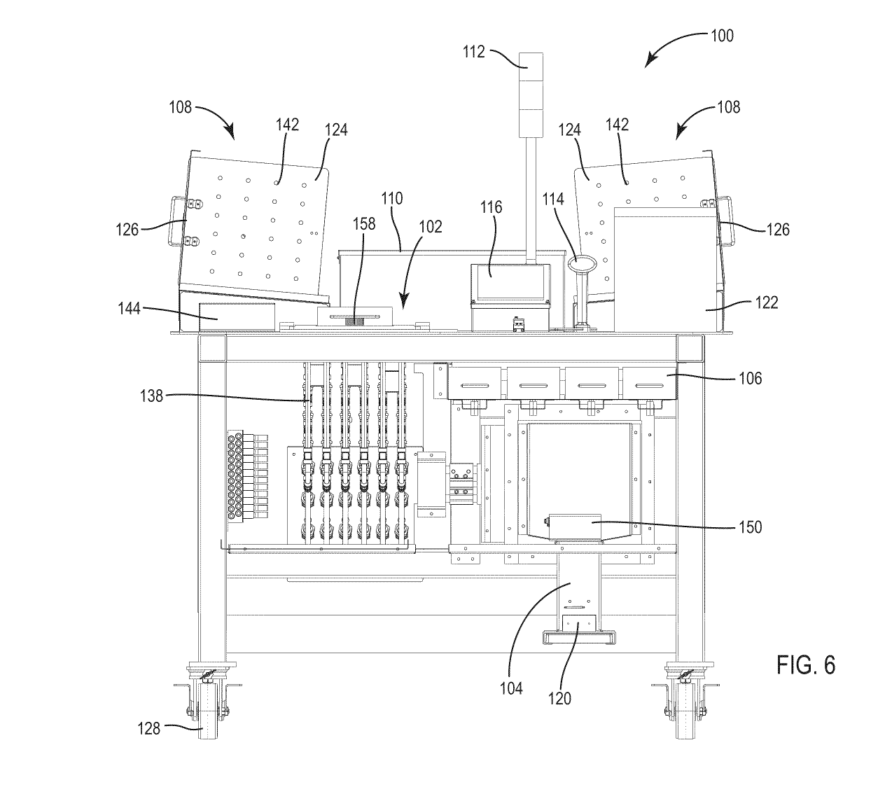

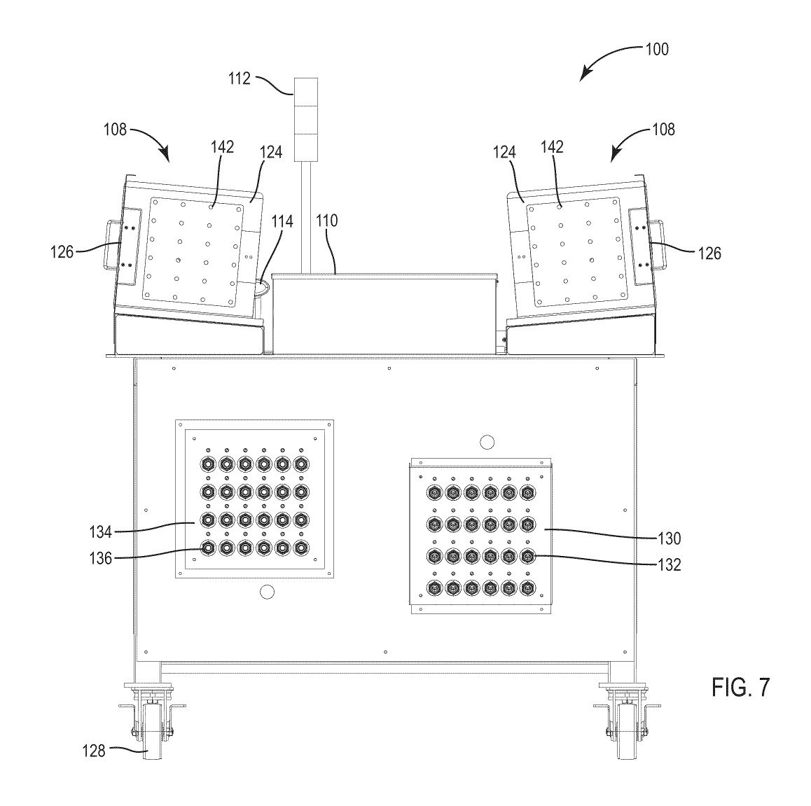

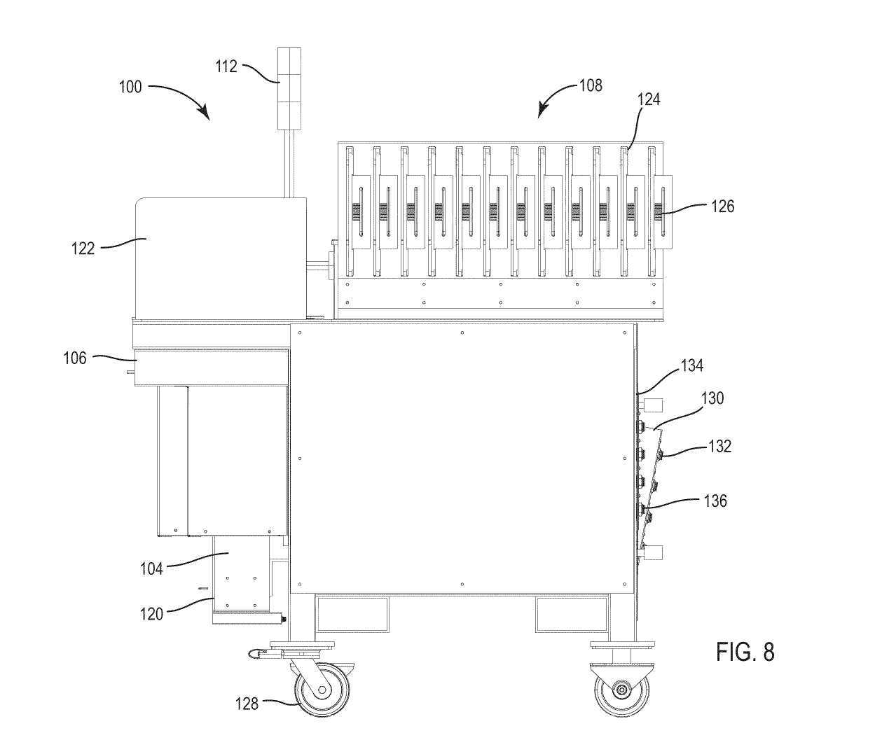

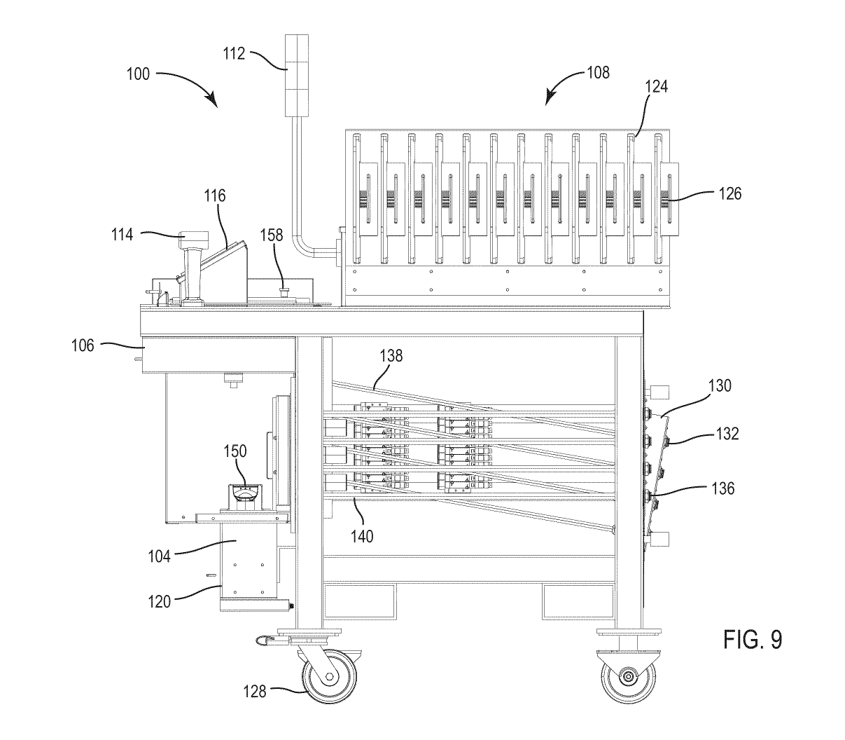

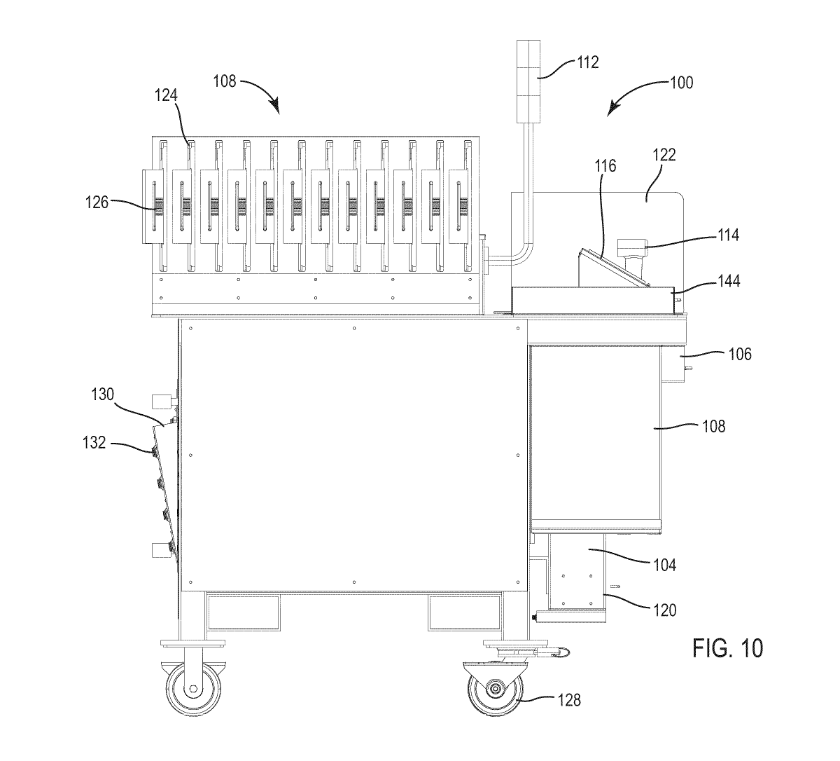

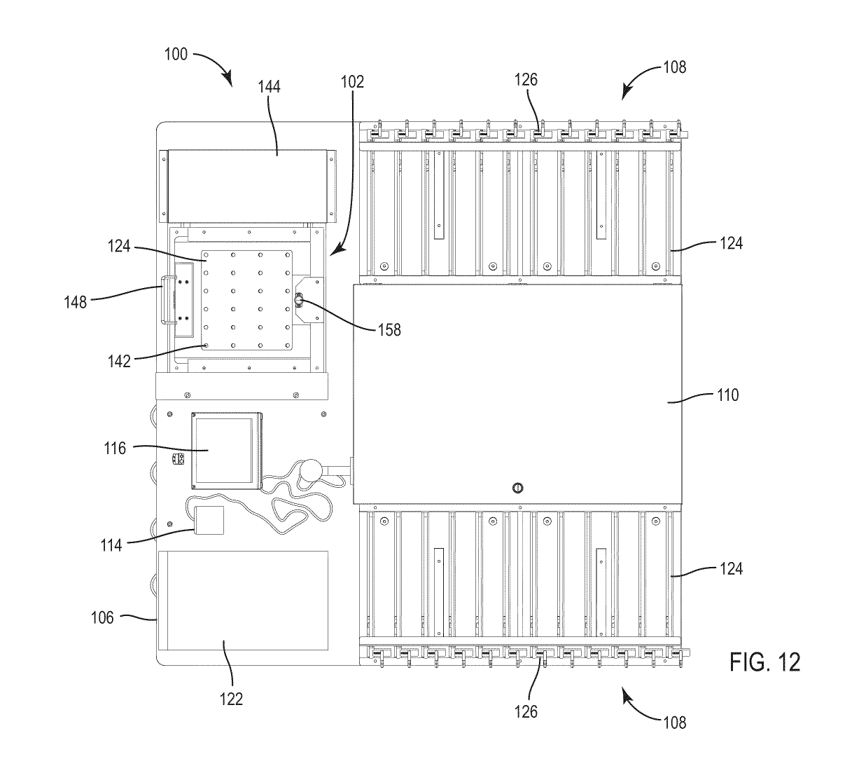

Referring to FIGS. 1 through 12, a microduct testing apparatus 100 is shown, according to an exemplary embodiment. The testing apparatus 100 is configured to be coupled to all ducts within a group of ducts (e.g., a bundle) in order to test one or more functions of the ducts. For instance, the testing apparatus 100 may be configured to test the ducts for obstructions, to verify that the ducts are absent of leaks, to test a continuity of a wire or fiber within the ducts, or to test another function of the ducts. In the illustrated embodiment, the testing apparatus 100 is configured to test a group of microducts shown as microduct bundle 200. The microduct bundle 200 is a collection of ducts stored within a sheath or housing and stored by wrapping the bundle 200 around spool 202.

The testing apparatus 100 is configured to perform a clearance test in order to verify that the microduct bundle 200 (i.e., each of the microducts within the bundle 200) is absent of obstructions that would affect the function of the bundle 200. For instance, the microduct bundle 200 may be used to store wire or optical fiber within a building and the microducts within the bundle 200 may require an opening large enough to house the wire or fiber. In an exemplary embodiment, the apparatus 100 is configured to force an object (e.g., a ball, a pellet, a bearing, etc.) through the length of the microduct bundle 200 in order to determine whether the bundle 200 includes a blockage that may limit the functionality of the bundle 200. In addition to the clearance test, the apparatus 100 may be configured to perform an air pressure test on the bundle 200 (e.g., to determine whether a leak is present) and/or to apply a continuity test to the bundle 200 (e.g., to determine a current flow through a wire or cable housed within the bundle 200). The pressure test and continuity test are discussed in further detail below.

In the illustrated embodiment, the testing apparatus 100 is portable, having wheel assemblies 128 configured to mobilize the apparatus 100. In this way, the apparatus 100 may be moved along a surface, such as to test more than one microduct bundle in a given area or to transport the apparatus 100 between locations. The wheel assemblies 128 may include locks configured to selectively stabilize (e.g., restrict movement of) the apparatus 100. In other embodiments, the apparatus 100 may include devices or components similar to the wheel assemblies 128 for mobilizing the apparatus 100. In still other embodiments, the apparatus 100 may be stationary.

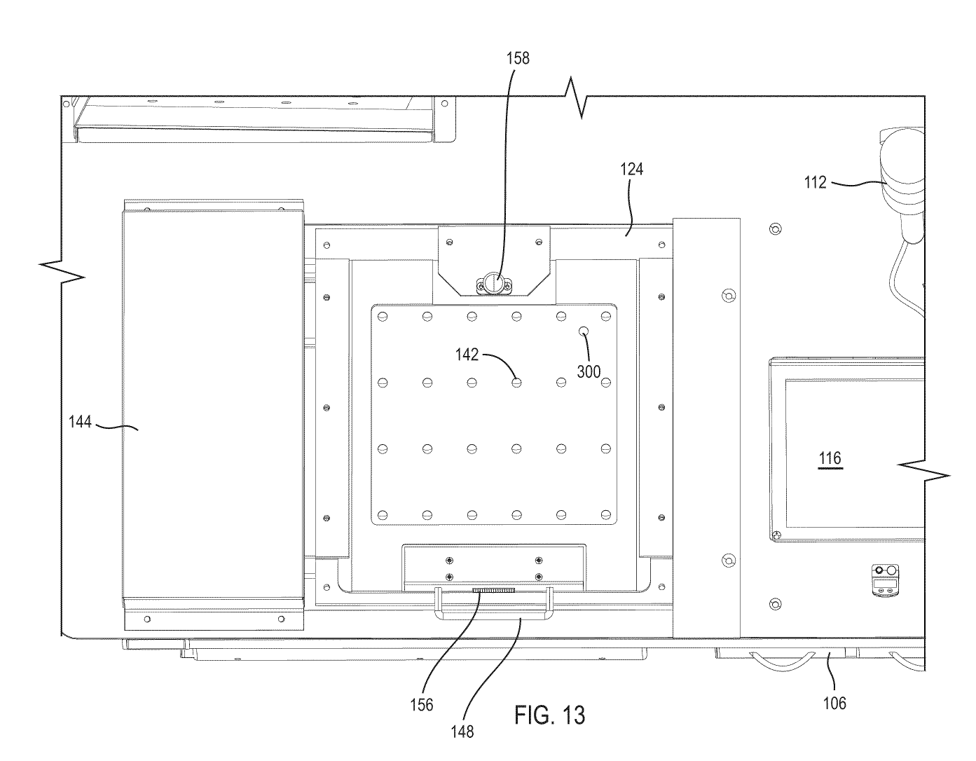

In an exemplary embodiment, the apparatus 100 is configured to perform the clearance test on the microduct bundle 200. As part of the clearance test, the apparatus 100 is configured to force (e.g., blow, send, move, etc.) an object such as pellet 300 (shown in FIG. 13) through each of the microducts within the bundle 200 by sending pressurized air through each of the microducts within the microduct bundle 200. The apparatus 100 is configured to send the pellets 300 into a first end of the microduct bundle 200, forcing the pellets 300 through the bundle 200 and receiving the pellets 300 from a second end of the bundle 200. The apparatus 100 includes a plurality of pellets 300 of varying sizes and shapes in order to fit each of the microducts being tested. If the pellet 300 is forced through the entire length of a microduct (e.g., into a first end of the microduct and out of a second end of the microduct), the microduct is validated as having a sufficient clearance. In an exemplary embodiment, the apparatus 100 performs the clearance test by sending one of the pellets 300 through each of the microducts of the bundle 200 simultaneously. In one embodiment, the apparatus 100 is configured to indicate that the bundle 200 passed the clearance test only if all pellets 300 pass through the microducts of the bundle 200 and are received on the second end of the bundle 200. The apparatus 100 may also be configured to indicate an individual passing or failing designation for each of the microducts within the bundle 200 based on the pellets 300 received from the second end of the bundle 200.

The pellets 300 are configured (e.g., sized, shaped, etc.) to flow through the microduct bundle 200 in response to the pressurized air. In an exemplary embodiment, the pellets 300 have a round shape and are made from a lightweight material (e.g., plastic) configured to allow the pellets 300 to move more easily through the bundle 200 (e.g., in response to a lesser air pressure). In another embodiment, the pellets 300 are made from a more durable material intended to maintain the shape or weight of the pellets 300. In an exemplary embodiment, the apparatus 100 includes a plurality of pellets 300 that are sized and shaped to test a variety of microducts. In an exemplary embodiment, each pellet 300 has a diameter that is approximately sixty percent of the diameter of the corresponding microduct in order to ensure sufficient clearance throughout the microduct. In other embodiments, the pellets 300 may be larger or smaller, depending on the clearance requirements of the microduct bundle 200.

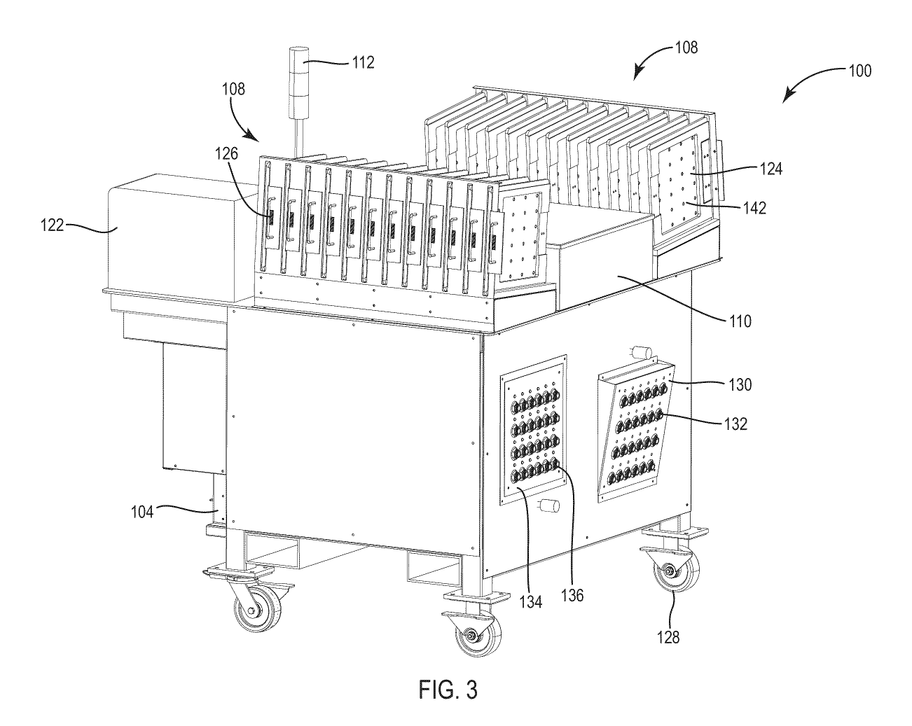

Referring now to FIG. 3, the apparatus 100 includes an outlet panel 130 housing a plurality of outlets 132. The outlets 132 are configured to connect to a first end of the microduct bundle 200. In an exemplary embodiment, the pellets 300 are sent through the outlets 132 and into the microduct bundle 200 during the clearance test by sending pressurized air through the outlets 132. The apparatus 100 also includes an inlet panel 134 housing a plurality of inlets 136. The inlets 136 are configured to connect to a second end of the microduct bundle 200. In an exemplary embodiment, the pellets 300 are received from the microduct bundle 200 through the inlets 136 during the clearance test.

The outlets 132 and inlets 136 are sized and shaped to allow each of the pellets 300 used by the apparatus 100 to flow through the outlets 132 and the inlets 136. For instance, the apparatus 100 may be used to test a variety of microduct bundles. Each of the microduct bundles may include a different number of microducts for testing. In addition, the microducts within the bundle may be of varying size (e.g., diameter), even within a particular bundle. Thus, the testing apparatus 100 may be configured to test each of the different microduct bundles. In one embodiment, the outlets 132 and inlets 136 are sized based on the microducts being tested by the apparatus 100. For instance, the outlets 132 and inlets 136 may have a diameter at least as great as the diameter of the largest microduct tested by the apparatus 100 (e.g., the largest microduct within the bundle 200, the largest microduct intended for the apparatus 100, etc.). In another embodiment, the outlets 132 and the inlets 136 each have a diameter at least as great as the diameter of the largest pellet 300 used for the clearance test. In other embodiments, the outlets 132 and inlets 136 may be sized and/or shaped according to any connectors required to connect the outlets 132 and inlets 136 to the microduct bundle 200, according to air pressure requirements of the apparatus 100, or otherwise based on the testing requirements of the apparatus 100.

The number of inlets 136 and outlets 132 may also be configured such that the apparatus 100 is able to test a variety of microduct bundles. The apparatus 100 is shown in the illustrated embodiment to include twenty-four (24) inlets 136 and twenty-four (24) outlets 132. In this embodiment, the apparatus 100 is configured to test a microduct bundle having up to twenty-four (24) individual microducts. However, in other embodiments, the apparatus 100 may include any number of inlets 136 and/or outlets 132 as may be suitable for the particular application of the apparatus 100. In an exemplary embodiment, the number of inlets 136 and outlets 132 are based on the microduct bundle(s) for which the apparatus 100 is intended. For instance, the apparatus 100 may be used to test a specific line of products and the number of inlets 136 and outlets 132 may be based on the bundle having the greatest number of microducts within the line of products. In some embodiments, the apparatus 100 may include a different number of inlets 136 than outlets 132. In exemplary embodiments, the apparatus 100 includes at least as many inlets 136 and outlets 132 as the number of microducts within the microduct bundle 200, such that a first end of each microduct is able to connect to its own outlet 132 and a second end of each microduct is able to connect to its own inlet 136.

The inlets 136 and the outlets 132 may include valves configured to open and close the inlets 136 and the outlets 132, respectively. In an exemplary embodiment, each of the inlets 136 and outlets 132 includes a valve configured to open and close, such as to fluidly connect and disconnect the apparatus 100 to a coupled microduct bundle 200. When the microduct bundle 200 is coupled to the inlets 136 and the outlets 132, the valves may be opened to force pressurized air into the bundle 200, and then closed to create a closed environment within the bundle 200, such as to perform a pressure test of the bundle 200. The microduct bundle 200 may be physically coupled to the outlets 132 or the inlets 136 by a connector having a first end configured to connect to one or more microducts and a second end configured to connect to the inlets 136 and/or the outlets 132.

Referring still to FIGS. 1 through 12, the apparatus 100 also includes testing plate racks 108 for housing a plurality of testing plates 124 (e.g., cartridges, trays, frames, etc.). In the illustrated embodiment, two testing plate racks 108 are positioned on opposite sides of the apparatus 100, but in other embodiments the testing plates 124 may be otherwise stored and/or positioned on the apparatus 100. Each of the testing plates 124 includes a pattern of holes 142 (e.g., slots, openings, markers, guides, etc.) that are formed through the testing plates 124 and configured to receive the pellets 300 (see FIGS. 13-15 for further detail). Each of the testing plates 124 includes a pattern of holes 142 which may be unique to the particular testing plate 124. In an exemplary embodiment, the apparatus 100 is configured to test a number of different microduct bundles having different amounts of microducts in a variety of sizes. In this embodiment, the apparatus 100 includes a testing plate 124 uniquely configured to test each of the various microduct bundles. For instance, each of the microduct bundles being tested by the apparatus 100 may have a particular testing plate 124 assigned to the bundle and suited for testing the particular bundle. The number of holes 142 within the assigned testing plate 124 would then correspond to the number of microducts within the particular microduct bundle and the holes 142 would also be sized accordingly (i.e., relative to a diameter of the microducts).

In the illustrated embodiment, the testing plate 124 is assigned to the microduct bundle 200 and the number of holes 142 within the assigned testing plate 124 corresponds to the number of microducts within the bundle 200. The size (e.g., diameter) of the microducts of bundle 200 are also related to the size (e.g., diameter) of the holes 142 of the assigned testing plate 124 such that the pellets 300 used to perform a clearance test of the microduct bundle 200 are each able to pass through a corresponding hole 142 on the testing plate 124 simultaneously. As an example, in an embodiment in which the microduct bundle 200 requires five relatively small pellets 300 and three relatively large pellets 300 (e.g., the microduct bundle 200 includes five relatively small microducts and three relatively large microducts), the assigned testing plate 124 may include five relatively small holes 142 and three relatively large holes 142 for receiving the pellets 300. As will be described in further detail below, the apparatus 100 may require a particular testing plate 124 and a particular set of pellets 300 to be used in order to begin the clearance test (or another test of the apparatus 100).

Referring still to FIGS. 1 through 12, the apparatus 100 also includes controller 110. The controller 110 may be coupled, communicatively or otherwise, to one or more components of the apparatus 100. The controller 110 may be configured to send and/or receive signals from the one or more components, such as to control the components. In an exemplary embodiment, the controller 110 is configured to identify the microduct bundle 200 based on information received from the one or more components of the apparatus 100 and/or an operator of the apparatus 100. The controller 110 may be configured to modify and/or select a particular test program based on identification of the bundle 200. In the illustrated embodiment, the apparatus 100 includes a scanner 114 coupled to the controller 110 and configured to scan a bar code of the microduct bundle 200. The barcode may be positioned on the microduct bundle 200 or otherwise. At the start of the clearance test, for instance, an operator of the apparatus 100 may scan a barcode of the microduct bundle 200 (e.g., using the scanner 114) to determine an appropriate test sequence. The scanner 114 may be configured to send (e.g., via an electronic signal) the barcode and/or any information within the barcode, including information identifying the microduct bundle 200, to the controller 110 upon scanning the barcode. In response, the controller 110 may identify the microduct bundle 200 and/or determine an appropriate test program or sequence for the microduct bundle 200. Based on the identifying information, the controller 110 may also determine the number of microducts to be tested within the bundle 200, the type of pellets 300 required, the testing plate 124 to be used, the proper connectors and/or adapters for connecting the microduct bundle 200 to the apparatus 100, and/or any other requirements related to the specific microduct bundle 200.

In an exemplary embodiment, the controller 110 is configured to determine the testing plate 124 assigned to the microduct bundle 200 based on the information received (e.g., barcode information received via the scanner). In this embodiment, the testing plate 124 is uniquely configured to test the identified microduct bundle 200. For instance, the testing plate 124 includes a number of holes 142 that corresponds to the number of microducts within the bundle 200 and the number of pellets 300 required to perform the clearance test. The holes 142 of the assigned testing plate 124 may also be sized and shaped to receive the required pellets 300. The controller 110 is configured to positively identify the microduct bundle 200 and assign the corresponding testing plate 124 in order to inform the operator of the type and size of pellets 300 required for the clearance test and to increase the likelihood that the test will be performed properly.

In the illustrated embodiment, each of the testing plates 124 is stored within one of the testing plate racks 108. In this embodiment, the racks 108 include locking assemblies 126 (e.g., locks, switches, etc.) at each of the testing plates 124 configured to retain the testing plates 124 within the racks 108. Each of the locking assemblies 126 includes a locked position for preventing the associated testing plate 124 from being removed from the testing plate rack 108 and an unlocked position for allowing the testing plate 124 to be removed. In an exemplary embodiment, the controller 110 is coupled to the locking assemblies 126 and configured to detect movement of the locking assemblies 126 between the locked and unlocked position via an electronic signal. For instance, the controller 110 may be configured to determine the testing plate 124 assigned to the microduct bundle 200 based on identification of the microduct bundle 200. The assigned testing plate 124 may be included as information within the barcode or otherwise determined by the controller 110 (e.g., based on the testing sequence). Once the assigned testing plate 124 is determined, the controller 110 may be configured to move the associated locking assembly 126 to the unlocked position, allowing the operator to remove the assigned testing plate 124 from the testing plate rack 108. In an exemplary embodiment, the controller 110 is configured to open only one of the locking assemblies 126 at any time, such that the operator is required to use only the assigned testing plate 124. Thus, the operator will be required to use the assigned testing plate 124 to perform the clearance test, minimizing the likelihood of operator error and increasing the likelihood that the test will be performed properly.

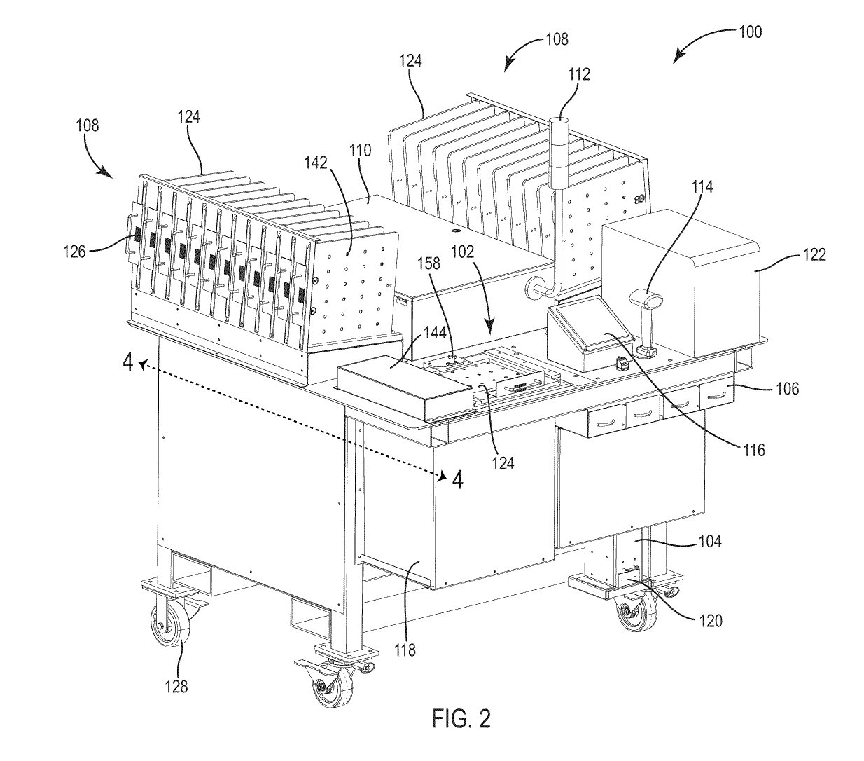

Once the assigned testing plate 124 is removed from the testing plate rack 108, the controller 110 may send a message to the operator (e.g., via screen 116) validating the testing plate 124 selection and/or prompting the operator to place the testing plate 124 within a staging area 102 of the apparatus 100. The testing plate 124 is shown positioned within the staging area 102 in FIG. 2 (and in greater detail in FIG. 13). The testing plate 124 is receivable within the staging area 102 in a load position and is movable between the load position and an unload position once the testing plate 124 is received within the staging area 102. In an exemplary embodiment, the testing plate 124 is locked (automatically or manually) into the load position by a locking assembly 158 upon installation within the staging area 102. The controller 110 is configured to verify that the assigned testing plate 124 is positioned within the staging area 102 before proceeding with the testing sequence. In one embodiment, the testing plates 124 include a barcode and the scanner 114 is configured to scan the barcode and send the barcode information to the controller 110. The controller 110 may then verify the assigned testing plate 124 based on the barcode information. In one embodiment, the staging area 102 includes a sensor (e.g., proximity sensor, vision sensor, etc.) coupled to the controller 110 and configured to monitor the staging area 102. The sensor (i.e., second sensor) may be configured to send a signal (e.g., a second signal) to the controller 110 upon detecting the presence of the testing plate 124 (e.g., in the load position). When the testing plate 124 is verified by the controller 110, the controller 110 may send a message to the display screen 116 or otherwise convey the message to the operator.

Once the correct testing plate 124 is installed within the staging area 102, the controller 110 may be configured to indicate which of the outlets 132 and the inlets 136 are required to be connected to the microducts of the microduct bundle 200 in order to proceed with the clearance test sequence. The controller 110 may send the information to the operator via the display screen 116. In one embodiment, the inlets 136 and the outlets 132 include indicators (e.g., lights) and the controller 110 is configured to visually display the required inlets 136 and outlets 132 using the indicators. The controller 110 may also indicate a type of intermediate connector required to connect the outlets 132 and inlets 136 to the microduct bundle 200.

Referring still to FIGS. 1 through 12, the apparatus 100 also includes drawers 106 configured to store pellets 300 for use in the clearance test. The pellets 300 may also be stored in another type of container in other embodiments. In an exemplary embodiment, the drawers 106 are configured to prevent or allow access to the pellets 300 based on the microduct bundle 200 being tested. For instance, the controller 110 may be coupled to the drawers 106 and configured to lock or unlock the drawers 106 (or another similar container) based on the microduct bundle 200. In one embodiment, the drawers 106 are configured to remain locked until a signal is sent from the controller 110 (e.g., based on the identification of the bundle 200). For instance, the drawers 106 may include electrical solenoids or other components in communication with the controller 110 and configured to lock and/or unlock one or more of the drawers 106 in response to a signal received from the controller 110. In one embodiment, the controller 110 is configured to send a signal to unlock only the one or more drawers containing the required pellets 300 once the microduct bundle 200 is identified and the testing plate 124 is installed within the staging area 102, leaving the remaining drawers 106 locked. Once the appropriate drawers 106 are unlocked, the operator is allowed to select the pellets 300 configured to fit within the holes 142 of the assigned and installed testing plate 124 and place the pellets 300 within the appropriate holes 142. In one embodiment, the drawers 106 may also include sensors configured to detect when pellets 300 are removed or added to the drawers 106. For instance, the drawers 106 may include a weight sensor configured to monitor a weight within the drawers 106 or a presence sensor configured to monitor when the drawer 106 is opened or closed. The controller 110 may be coupled to these sensors and configured to receive information from the sensors. The controller 110 may be configured to determine one or more conditions of the apparatus 100 or the testing cycle based on the information from the sensors.

The holes 142 of the testing plate 124 are sized and shaped to receive the pellets 300 intended for the microduct bundle 200. In the load position, the holes 142 are blocked such that the pellets 300 are not allowed to drop through the holes 142 (i.e., the holes 142 are fluidly disconnected from the outlets 132 and ducts 138). For instance, the staging area 102 may include valves configured to close when the testing plate 124 is in the load position, blocking the pellets 300 from entering the apparatus 100 and allowing the pellets 300 to rest within the holes 142. Similarly, the valves within the staging area 102 may be configured to open when the testing plate 124 is in the unload position, allowing the pellets 300 within the holes 142 to move toward the outlets 132 as part of the clearance test.

In an exemplary embodiment, the staging area 102 and/or the testing plate 124 may include one or more sensors (e.g., third sensor) configured to detect the required pellets 300 within the holes 142 of the testing plate 124. For instance, a sensor may be coupled to each of the holes 142 and configured to detect the required pellets 300 within the holes 142. The controller 110 may also be configured to display the required pellets 300 on the display screen 116. Upon detection of the required pellets 300 within the holes 142, the one or more sensors may be configured to send a signal (e.g., third signal) to the controller 110. In another embodiment, the controller 110 is configured to receive input from the operator (e.g., via the display screen 116) upon verification that the pellets 300 are within the required holes 142. Upon receiving verification that the correct pellets 300 have been placed within the holes 142 of the testing plate 124 (e.g., automatically via presence sensors, manually via the operator, etc.) the controller 110 is configured to allow the testing plate 124 to move to the unload position. For instance, the controller 110 may be coupled to the locking assembly 158 and configured to send a signal to release the locking assembly 158 and allow the testing plate 124 to move to the unload position. The locking assembly 158 may be a switch configured to prevent movement of the testing plate 124 in a specific direction. The testing plate 124 may be moved manually by the operator to the unload position by moving the testing plate 124 laterally within the staging area 102 (e.g., using handle 148). For instance, the testing plate 124 may be moved between the load and the unload position by either pushing or pulling the testing plate 124 using the handle 148.

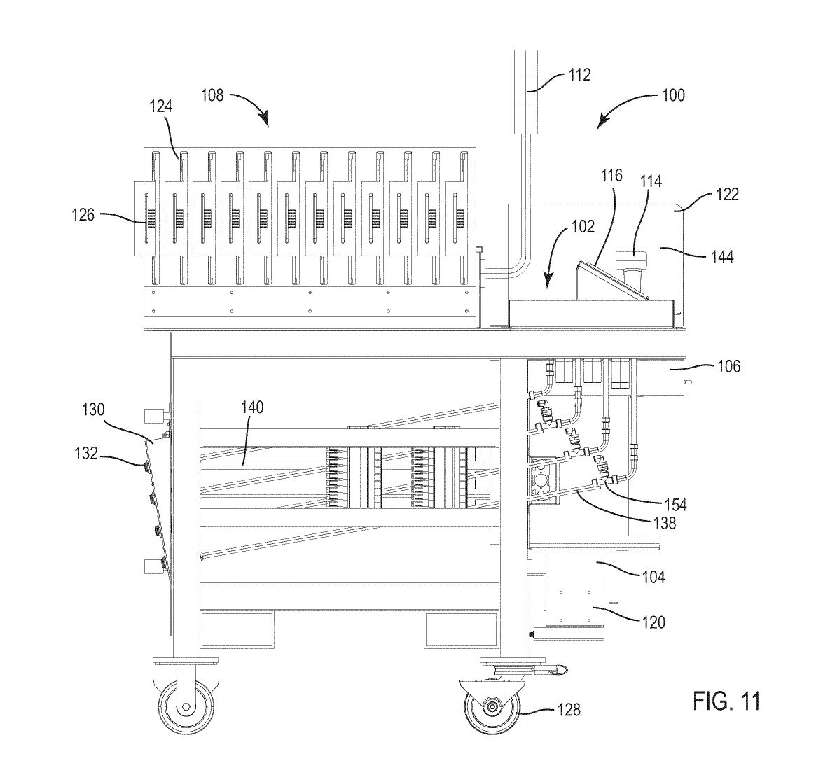

When the testing plate 124 is in the unload position, each of the holes 142 within the testing plate 124 are fluidly connected to a corresponding testing duct 138 (shown in FIG. 11) stored at least partially within a housing 118 of the apparatus 100. In this position, the pellets 300 within the holes 142 are allowed to flow into the testing ducts 138. The testing ducts 138 are coupled to the outlets 132 in order to send the pellets 300 to the microduct bundles 200 for testing. In an exemplary embodiment, the apparatus 100 includes at least as many testing ducts 138 as outlets 132, with each of the testing ducts 138 coupled to a corresponding outlet 132. The testing ducts 138 are positioned to receive the pellets 300 from the holes 142 of the testing plate 124, with each testing plate 124 having a hole pattern in which each of the holes 142 is aligned with the testing ducts 138. The testing ducts 138 are configured to allow the pellets 300 to flow through the ducts 138. In an exemplary embodiment, the ducts 138 are sized to allow each of the pellets 300 used within the apparatus 100 to flow through the ducts 138. The ducts 138 may include valves such as valve 154 configured to open and close in order to control air flow through the ducts 138, other components of the apparatus 100, and/or the microduct bundle 200. The controller 110 may be communicatively coupled to the valves and configured to control the valves.

In an exemplary embodiment, the apparatus 100 is configured to send pressurized air through the testing ducts 138 to move the pellets 300 through the apparatus 100. For instance, the apparatus 100 may include a pneumatic device configured to generate and send pressurized air through the apparatus or otherwise generate an air pressure sufficient to move the pellets 300 through the microduct bundle 200 as part of the clearance test. When the testing plate 124 is moved to the unload position, pellets 300 from each of the holes 142 fall within the testing ducts 138. At this time, the apparatus 100 may require the operator to confirm that all of the pellets 300 from the testing plate 124 have dropped within the testing ducts 138. For instance, the controller 110 may send a signal or request to the operator via the display screen 116 and the operator may send a confirmation to the controller 110 using the same screen 116.

Once the pellets 300 are within the testing ducts 138, the controller 110 is configured to run the remainder of the clearance test sequence. As part of the clearance test, the pellets 300 are forced by pressurized air through the testing ducts 138, through the open outlets 132, through each of the microducts within the connected bundle 200, and through the open inlets 136. In an exemplary embodiment, the inlets 136 are coupled to a container 104 configured to receive the pellets 300. The container 104 is connected to the inlets 136 by ducts 140. When the inlets 136 are open, the pellets 300 are forced through the inlets 136 and the ducts 140 by the pressurized air, collecting within the container 104. A sensor assembly 150 (e.g., a first sensor) may be coupled to the container 104 and configured to detect the presence of the pellets 300 within the container 104. In an exemplary embodiment, the sensor assembly 150 includes a vision sensor configured to detect the presence of the pellets 300 within the container 104 by capturing an image. In another embodiment, the sensor assembly 150 may include a weight sensor configured to detect the presence of the pellets 300 within the container 104 by monitoring a weight within the container 104. In another embodiment, the sensor assembly 150 may include a presence sensor configured to detect the pellets 300 as the pellets 300 enter the container 104. In still other embodiments, the sensor assembly 150 may include other sensors configured to otherwise detect the presence of the pellets 300 within the container 104.

The sensor assembly 150 is used to verify that each of the required pellets 300 is present within the container 104. For instance, the sensor assembly 150 may be configured to identify the pellets 300 within the container 104 (e.g., by size, by shape, by color, etc.) and send the information to the controller 110 via an electronic signal (e.g., a first signal). The controller 110 may be configured to match the pellet information from the sensor assembly 150 against the microduct bundle information to determine that each pellet 300 sent to the bundle 200 traveled entirely through the bundle 200 and back to the apparatus 100. In an exemplary embodiment, the sensor assembly 150 is configured to monitor the container 104 for a predetermined period of time. The sensor assembly 150 may be configured to continuously send pellet information to the controller 110 during the predetermined period of time or send the information only after the predetermined period of time. If the controller 110 verifies that all required pellets 300 are within the container 104, the controller 110 is configured to provide an indication to the operator that the microduct bundle 200 has passed the clearance test. In an exemplary embodiment, the controller 110 is coupled to an indicator 112 and configured to send a signal to the indicator 112 in order to provide the indication of a passed test. In the illustrated embodiment, the indicator 112 is a multi-colored light configured to provide a visual indication of a passed test (e.g., a green light). However, in other embodiments, the indicator 112 may include a speaker configured to provide an audible indication or another type of indicator configured to provide visual, audible, tactile, or other sensory feedback to an operator. If, after the predetermined period of time, the controller 110 is unable to verify that all required pellets 300 are within the container 104, the controller 110 is configured to provide an indication to the operator that the microduct bundle 200 has failed the clearance test. In an exemplary embodiment, the controller 110 is configured to send a signal to the indicator 112 to provide an indication of a failed test (e.g., a red light).

The container 104 includes a door 120 that remains locked while the clearance test is running When the clearance test is complete and the apparatus 100 has provided an indication of a passed or failed test, the door 120 is configured to unlock. In an exemplary embodiment, the controller 110 sends a signal to a switch coupled to the door 120 in order to unlock the door 120. Once the door 120 is unlocked, an operator is able to open the door 120 and remove the pellets 300 from the container 104. At this time, the controller 110 may also be configured to open one or more of the drawers 106 so that the operator may replace the pellets 300 accordingly within the drawers 106. In one embodiment, the drawers 106 include sensors configured to detect the presence of the pellets 300 within the drawers 106. In this embodiment, the controller 110 may be configured to prevent another test using the apparatus 100 until the pellets 300 are detected in their required location within the drawers 106.

The apparatus 100 may also be configured to perform a pressure test. In an exemplary embodiment, the pressure test is performed for the microduct bundle 200 after the clearance test is completed. The controller 110 may be configured to initiate the pressure test automatically (e.g., after completion of the clearance test) or manually (e.g., in response to operator input). During the pressure test, the apparatus sends pressurized air into the microduct bundle 200 (e.g., via the outlets 132). The controller 110 is configured to monitor the microduct bundle 200 (e.g., using pressure sensors of the apparatus 100) to achieve a predetermined system pressure in a predetermined time. The controller 110 then stops the supply of pressurized air to the microduct bundle 200 and continues to monitor the air pressure within the bundle 200 for a specified period of time. After the specified period of time, the controller 110 is configured to measure the minimum pressure (e.g., overall within the microduct bundle 200, within each microduct, at the outlet 132, at the inlet 136, etc.). The controller 110 is configured to determine whether the microduct bundle 200 passes the pressure test based on this measured pressure (e.g., whether the microduct bundle 200 is absent of leaks). The controller 110 may be configured to provide an indication of whether the microduct bundle 200 passed the pressure test using the indicator 112, the display screen 116, or another component of the apparatus 100. In an exemplary embodiment, the controller 110 is configured to indicate a status of each microduct within the bundle 200 based on the pressure test (e.g., via the display screen 116).

The apparatus 100 may also be configured to perform a continuity test of wires or cables stored within the microduct bundle 200. In an exemplary embodiment, the apparatus 100 includes wire clamps configured to attach to opposite ends of wires or cables of the microduct bundle 200. The controller 110 is configured to determine whether an electric circuit can be formed through the wire or cable by sending an electric current through the wire or cable. The controller 110 is configured to provide an indication to the operator whether the microduct bundle 200 passes or fails the continuity test (e.g., via the indicator 112). The continuity test may be performed by the apparatus 100 automatically (e.g., after the pressure test) or manually based on an input from the operator.

The apparatus 100 also includes a printer 122. In an exemplary embodiment, the printer 122 is configured to print a label for the microduct bundle 200 based on the tests performed by the apparatus 100. For instance, if the microduct bundle 200 passes the clearance test (i.e., the microducts of the bundle 200 are clear of obstructions), the controller 110 may send a signal to the printer 122 indicating that the test was passed. The printer 122 may be configured to then print a label for the microduct bundle 200 based on the tests performed by the apparatus 100. The label may be placed on the microduct bundle 200 to indicate that the bundle 200 has passed one or more tests. The label may include information related to the bundle 200 and/or the tests performed, including the results of any tests, dates any tests were performed, a part number, the name of the operator who performed the test, and any other relevant information. The label may also include a barcode containing information related to the bundle 200. The barcode may be scannable by the scanner 114, such as to verify information related to the microduct bundle 200.

Referring now to FIGS. 13-15, the testing plate 124 is shown more particularly, according to an exemplary embodiment. In FIG. 13, the testing plate 124 is shown within the staging area 102 and pellets 300 are shown within the holes 142 of the testing plate 124. In this embodiment, the testing plate 124 includes a hole pattern having twenty-four (24) holes 142, with four rows and six columns of holes 142. In this embodiment, each of the holes 142 are approximately equal in shape and size and are uniformly spaced throughout the testing plate 124. However, in other embodiments the holes 142 may have a different shape or be non-uniform in shape and may also be spaced in a non-uniform manner.

The testing plate 124 is shown in the load position in FIG. 13 and the locking assembly 158 is shown in a lock position, preventing the testing plate 124 from being moved to the unload position. In another embodiment, the locking assembly 158 is a manual lock that may be manipulated by the operator to selectively hold the testing plate 124 in place. The staging area 102 is shown to include a sensor or switch 156 that is configured to detect the presence of the testing plate 124 within the staging area 102. The switch 156 may also be configured to monitor or detect a position of the testing plate 124. The switch 156 may be coupled to the controller 110 and configured to send signals to the controller 110 indication a presence and/or position of the testing plate 124 within the staging area 102. The staging area 102 also includes a housing 144 positioned adjacent to the testing plate 124. The housing 144 may contain one or more components configured to control the locking assembly 158 or the pneumatic device. The housing 144 may also contain one or more sensors configured to detect a presence of the pellets 300 within the holes 142 and/or a presence and/or position of the testing plate 124.

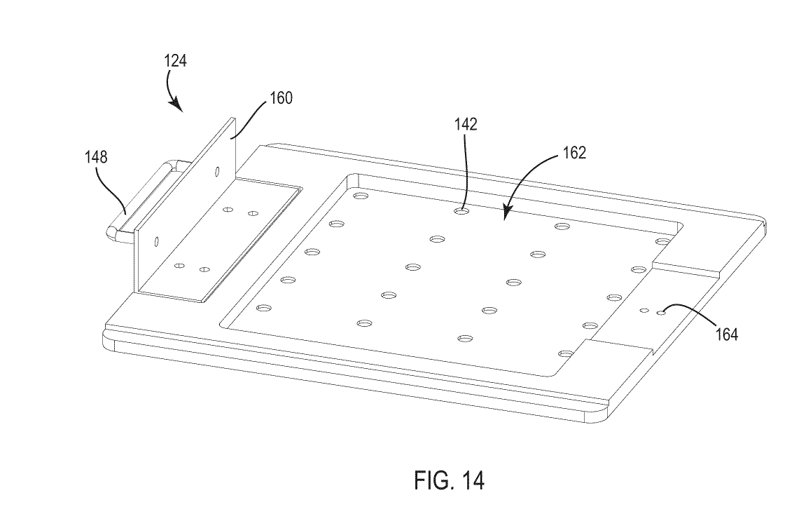

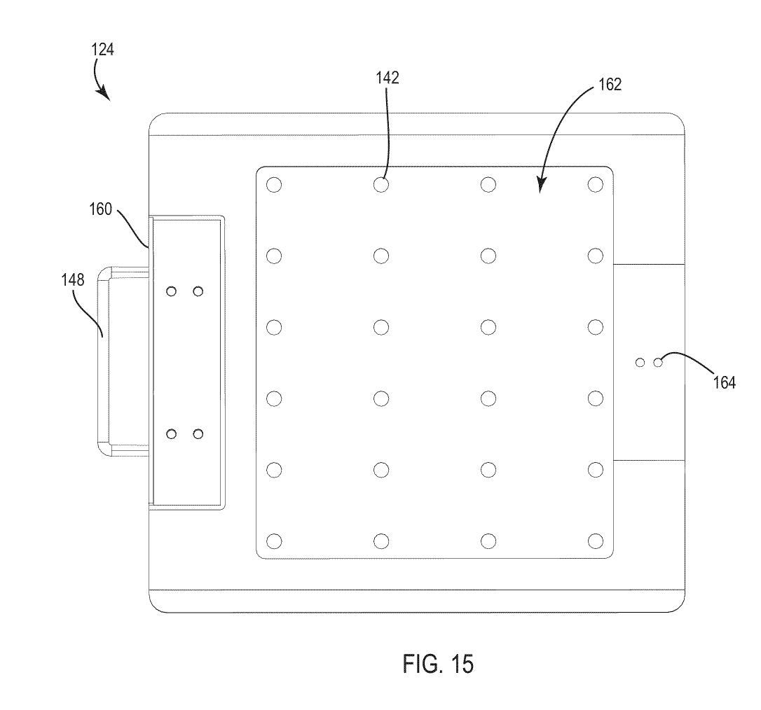

In FIGS. 14 and 15, the testing plate 124 is shown as a separate component from the apparatus 100, according to an exemplary embodiment. In this embodiment, the testing plate 124 includes holes 164 configured to receive the locking assembly 158 in order to lock the testing plate 124 within the staging area 102. The testing plate 124 has a recessed surface 162 configured to receive the pellets 300 and prevent the pellets 300 from rolling away from the testing plate 124 as the operator is attempting to place the pellets 300 within the holes 142. A vertical surface 160 is attached to the handle 148 and may be used to limit movement of the testing plate 124 as the testing plate 124 is installed within the staging area 102.

The construction and arrangement of the microduct testing apparatus, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An apparatus for testing a microduct, the apparatus comprising:
an outlet configured to connect to a first end of the microduct;
an inlet configured to connect to a second end of the microduct;
an object sized to flow through the microduct in response to a sufficient air pressure;
a test passage coupled to the outlet and configured to receive the object;
a testing plate having a hole sized to receive the object, the hole being configured to fluidly connect to the test passage to allow the object to pass through the hole into the test passage;
a container coupled to the inlet and configured to receive the object from the microduct via the inlet;
a pneumatic device configured to provide the sufficient air pressure to move the object through the microduct and into the container when the first end of the microduct is connected to the outlet and the second end of the microduct is connected to the inlet;
a first sensor configured to generate a first signal upon detecting the object within the container; and
a controller coupled to the first sensor and configured to:
upon receiving the first signal from the first sensor, provide a first indication; and
if the first signal is not received within a specified time period, provide a second indication.

2. The apparatus of claim 1, wherein the testing plate is movable from a load position in which the hole is substantially blocked to prevent the object from passing through the hole, to an unload position in which the hole is substantially clear to allow the object to pass through the hole and into the test passage.

3. The apparatus of claim 2, further comprising:
a storage container configured to store the object; and
a second sensor configured to monitor the testing plate and generate a second signal when the testing plate is placed in the load position;
wherein the controller configured to control access to the storage container and to allow access to the storage container only upon receiving the second signal.

4. The apparatus of claim 2, further comprising:
a third sensor configured to generate a third signal upon detecting the object within the hole;
wherein the controller is configured to, only upon receiving the third signal from the third sensor, allow the testing plate to move from the load position to the unload position and cause the pneumatic device to provide the sufficient air pressure to move the object from the test passage through the microduct and into the container.

5. The apparatus of claim 1, wherein the first sensor includes a vision sensor configured to detect the object within the container by obtaining an image of the object.

6. The apparatus of claim 1, wherein the controller is configured to identify the microduct and select the testing plate from a plurality of testing plates based on the identification of the microduct.

7. The apparatus of claim 6, further comprising:
a rack configured to store the plurality of testing plates;
wherein the controller is configured to control access to the plurality of testing plates within the rack and to allow access to the selected testing plate only upon identification of the microduct.

8. The apparatus of claim 6, further comprising:
a scanner configured to scan a barcode of the microduct;
wherein the controller is configured to receive the barcode and to identify the microduct based on the barcode.

9. An apparatus for testing a microduct bundle having a plurality of microducts, the apparatus comprising:
outlets configured to connect to a first end of the microduct bundle;
inlets configured to connect to a second end of the microduct bundle;
objects configured to flow through the plurality of microducts in response to a sufficient air pressure;
test passages coupled to each of the outlets and configured to receive the objects;
a plurality of testing plates, wherein each of the testing plates includes at least one hole sized to receive one of the objects;
a rack configured to store the plurality of testing plates, wherein the rack includes a locking assembly configured to prevent removal of the testing plates from the rack;
a staging area configured to receive each of the testing plates, wherein each of the testing plates is movable from a load position to an unload position within the staging area, wherein the at least one hole is substantially blocked in the load position such that the objects cannot pass through the at least one hole, and wherein the at least one hole is substantially clear in the unload position such that one of the objects may pass through the hole and into the test passage;
a container coupled to the inlets and configured to receive the objects from the microduct bundle via the inlets;
a pneumatic device configured to provide the sufficient air pressure to move the objects from the test passages through the microduct bundle and into the container when the first end of the microduct bundle is connected to the outlets and the second end of the microduct bundle is connected to the inlets;
a first sensor configured to monitor the container and generate a first signal upon detecting the objects within the container; and
a controller coupled to the locking assembly and the first sensor and configured to:
based on the microduct bundle, allow removal of a selected testing plate from the rack by sending a signal to the locking assembly;
upon receiving the first signal from the first sensor, provide a first indication; and
if the first signal is not received within a specified time period, provide a second indication.

10. The apparatus of claim 9, further comprising:
a storage container configured to store the objects; and
a second sensor configured to monitor the staging area and generate a second signal when the selected testing plate is placed in the load position;
wherein the controller configured to control access to the storage container and to, upon receiving the second signal, allow access to selected objects within the storage container based on the microduct bundle.

11. The apparatus of claim 9, further comprising:
an indicator coupled to the controller and configured to convey the first indication and the second indication based on a signal received from the controller.

12. The apparatus of claim 9, wherein the first sensor includes a vision sensor configured to detect the objects within the container by obtaining an image of the objects.

13. The apparatus of claim 9, further comprising:
a scanner coupled to the controller and configured to scan a barcode of the microduct bundle;
wherein the controller is configured to determine the selected testing plate based on the barcode.

14. The apparatus of claim 9, further comprising:
a third sensor configured to monitor the holes of the selected testing plate when the testing plate is in the load position;
wherein the controller is configured to communicate with the third sensor and to prevent movement of the testing plate from the load position to the unload position until a signal is received from the third sensor indicating that each hole of the selected testing plate holds one of the objects.

15. A method for providing an apparatus for testing a microduct, the method comprising:
providing an object sized to flow through the microduct in response to a sufficient air pressure;
providing a test passage configured to fluidly connect to a first end of the microduct and sized to receive the object;
providing a testing plate having a hole sized to receive the object, wherein the testing plate is configured to be received by a staging area of the apparatus, and wherein the testing plate is movable within the staging area from a load position to an unload position, wherein the hole is closed to store the object in the load position and the hole is open to allow the object to enter the test duct in the unload position;
providing a container configured to be fluidly connected to a second end of the microduct and to receive the object from the microduct, wherein the container includes a first sensor configured to generate a first signal upon detecting the object within the container;
providing a pneumatic device coupled to the test duct and configured to provide the sufficient air pressure; and
providing a controller coupled to the first sensor and configured to:
upon receiving the first signal from the first sensor, provide a first indication; and
if the first signal is not received within a specified time period, provide a second indication.

16. The method of claim 15, wherein the controller is configured to identify the microduct and provide a selection of the testing plate based on identification of the microduct.

17. The method of claim 16, further comprising:
providing a scanner coupled to the controller and configured to scan a barcode of the microduct;
wherein the controller is configured to identify the microduct based on the barcode.

18. The method of claim 15, further comprising:
providing a storage container coupled to the controller and configured to store the object; and
providing a second sensor configured to monitor the testing plate and generate a second signal when the testing plate is placed in the load position;
wherein the controller configured to control access to the storage container and to allow access to the storage container only upon receiving the second signal.

19. The method of claim 15, wherein the first sensor includes a vision sensor configured to detect the object within the container by obtaining an image of the object.

20. The method of claim 15, further comprising:
providing a third sensor configured to generate a third signal upon detecting the object within the hole when the testing plate is in the load position;
wherein the controller is configured to, only upon receiving the third signal, allow the testing plate to move from the load position to the unload position and cause the pneumatic device to provide the sufficient air pressure to move the object from the test chamber through the microduct and into the container.
